(19) United States
(12) Patent Application Publication
(10) Pub. No.: US 2013/0033896 A1
(43) Pub. Date: Feb. 7, 2013

(54) ELECTRONIC DEVICE WITH LIGHT BAR

(71) Applicants: YUN-LUNG CHEN, Tu-Cheng (TW); LIANG-CHIN WANG, Tu-Cheng (TW); LIN DING, Wuhan City (CN); CHUAN LIN, Wuhan City (CN)

(72) Inventors: YUN-LUNG CHEN, Tu-Cheng (TW); LIANG-CHIN WANG, Tu-Cheng (TW); LIN DING, Wuhan City (CN); CHUAN LIN, Wuhan City (CN)

(73) Assignees: HON HAI PRECISION INDUSTRY CO., LTD., Tu-Cheng (TW); HONG FU JIN PRECISION INDUSTRY (WuHan) CO., LTD., Wuhan City (CN)

(21) Appl. No.: 13/443,260

(22) Filed: Apr. 10, 2012

(30) Foreign Application Priority Data
Aug. 5, 2011 (CN) 201110223885.8

(51) Int. Cl. F21V 8/00

(52) U.S. Cl. 362/607; 362/613

(57) ABSTRACT

An electronic device includes a frame, a front panel secured to the frame, two light sources secured to the front panel, and a light bar. The frame includes a first sidewall, a second sidewall, and a top wall connected to the first sidewall and the second sidewall. A first supporting portion is located between the first sidewall and the top wall. A second supporting portion is located between the second sidewall and the top wall. The top wall, the first supporting portion, and the second supporting portion cooperatively define an installation hole. A light bar includes a body including a bridge and a light guiding portion located on the bridge. The bridge is located on the supporting portion and the second supporting portion. The light guiding portion is engaged in the installation hole. Two light sources are aligned with two opposite sides of the light guiding portion.

### BACKGROUND

1. Technical Field

The present disclosure relates to electronic devices, and particularly to an electronic device with a light bar.

2. Description of Related Art

In a computer system or a server system, a light-emitting member, such as an LED, is secured to an enclosure to indicate working states. The light-emitting member is very small so that the area irradiated by the light is very small.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device, the electronic device comprising a frame, a front panel, and a light bar comprising a body.

FIG. 2 is a cutaway, assembly view of the frame and the front panel of FIG. 1.

FIG. 3 is a cutaway, assembled view of the frame and the front panel of FIG. 1.

FIG. 4 is a cutaway, isometric view of the front panel of FIG. 1.

FIG. 5 is an isometric view of the body of FIG. 1.

FIG. 6 is similar to FIG. 5, but viewed in different aspect.

FIG. 7 is a cutaway, assembled view of the light bar and the frame.

FIG. 8 is an assembled view of the electronic device of FIG. 1.

FIG. 9 is a cross-sectional view of the electronic device of FIG. 8, taken along the line IX-IX.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

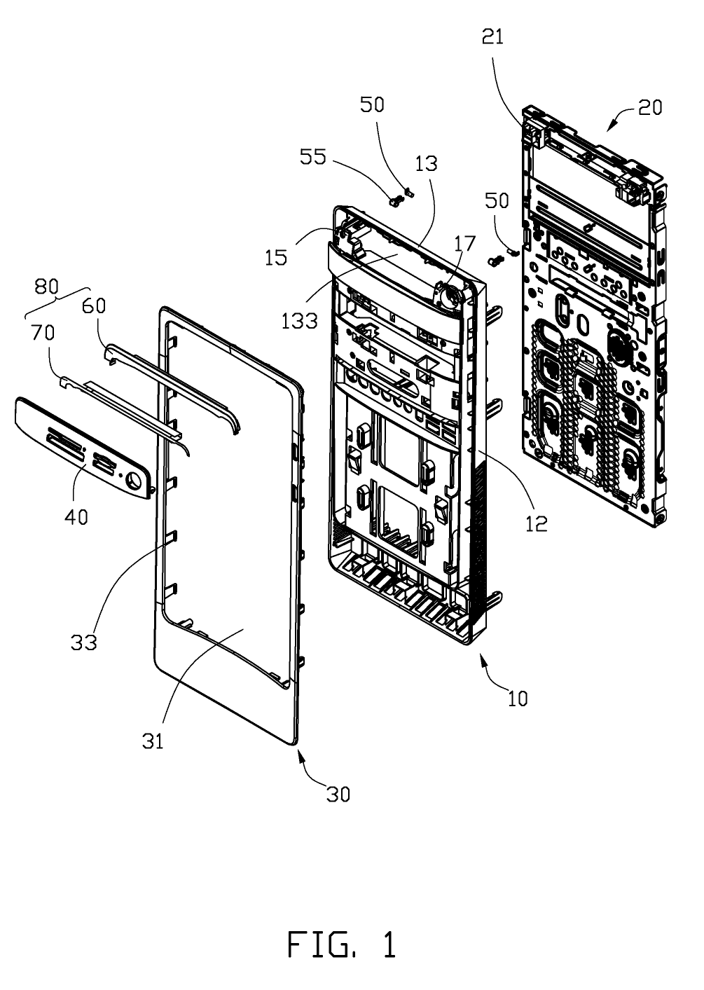

Referring to FIG. 1, an electronic device includes a frame 10, a front panel 20, a cover 30, an expansion board 40, two light sources 50, and a light bar 80.

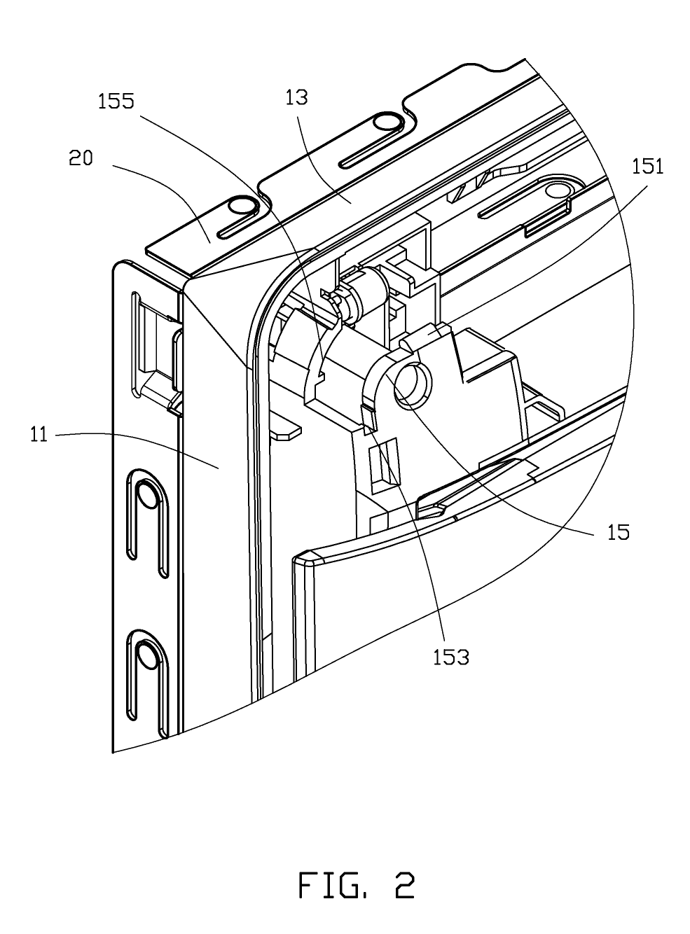

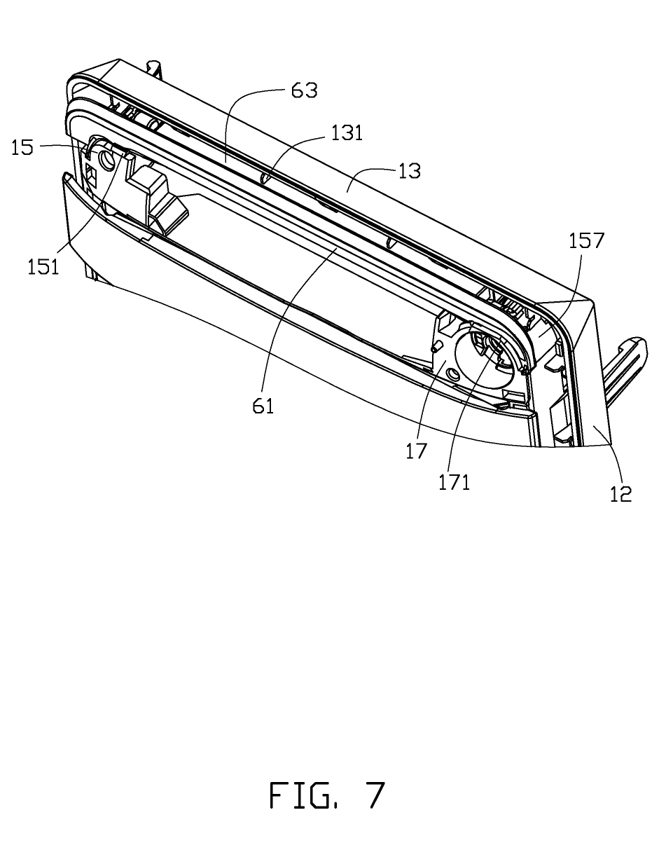

The frame 10 includes a first sidewall 11 (shown in FIG. 2), a second sidewall 12, and a top wall 13 connected to the first sidewall 11 and the second sidewall 12. A first supporting portion 15 is located in a corner between the first sidewall 11 and the top wall 13. A second supporting portion 17 is located in a corner between the second sidewall 12 and the top wall 13. A plurality of pressing portions 131 (only shown in FIG. 7) extends inward from the top wall 13. The top wall 13, a first supporting portion 15, and the second supporting portion 17 cooperatively define an installation opening 133.

Referring to FIG. 2, a blocking portion 151 is located on the first supporting portion 15. A slot 153 is defined in the first supporting portion 15. A limiting piece 155 extends from the first supporting portion 15. In one embodiment, the limiting piece 15 is substantially arc-shaped.

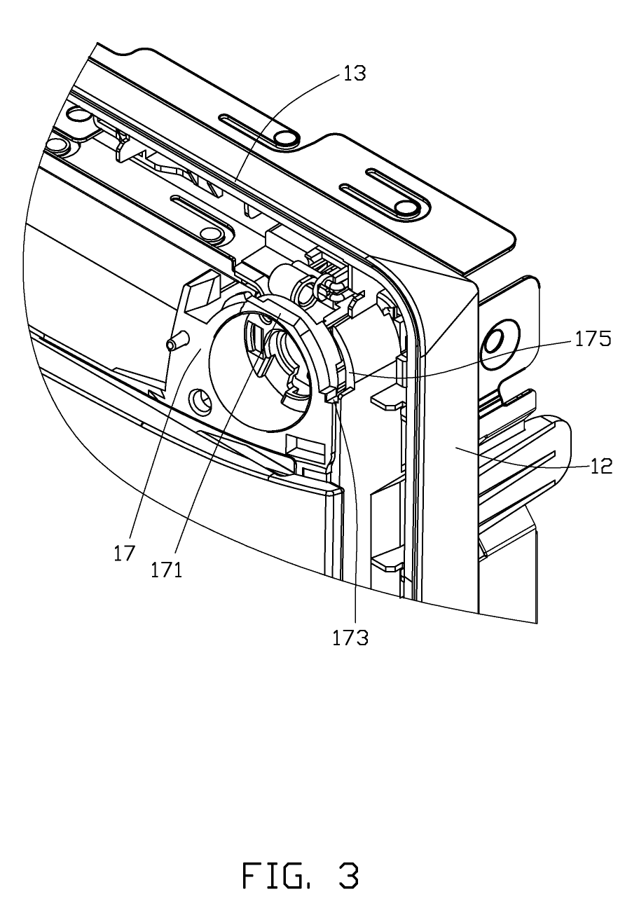

Referring to FIG. 3, a protrusion flange 171 is located on the second supporting portion 17. A recess 173 is defined in the second supporting portion 17. A stopping piece 175 extends from the second supporting portion 17 and adjacent to the second sidewall 12. In one embodiment, the stopping piece 175 is substantially arc-shaped.

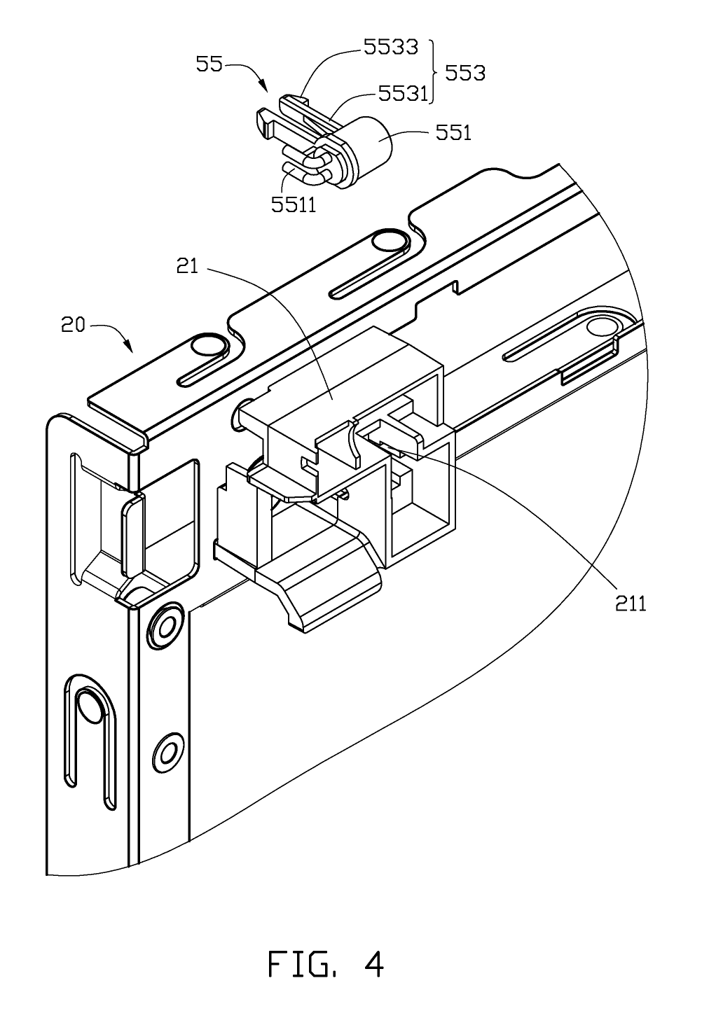

Referring to FIG. 4, two brackets 21 are located on the front of the front panel 20. Each of the two brackets 21 defines a through hole 211.

Referring to FIG. 1, the cover 30 defines an opening 31 configured to received the light bar 80. A plurality of gripping portions 33 are located on the cover 30 and arranged around the opening 31.

Each of the two light sources 50 is installed in each of two mounting members 55. Referring to FIG. 4, each of the mounting members 55 includes a receiving portion 551 and two hooks 553 located on the receiving portion 551. Two cables 5511 are located on the receiving portion 551. Each of the two hooks 553 includes a connecting portion 5531 and a stopping portion 5533 extending from the connecting portion 5531.

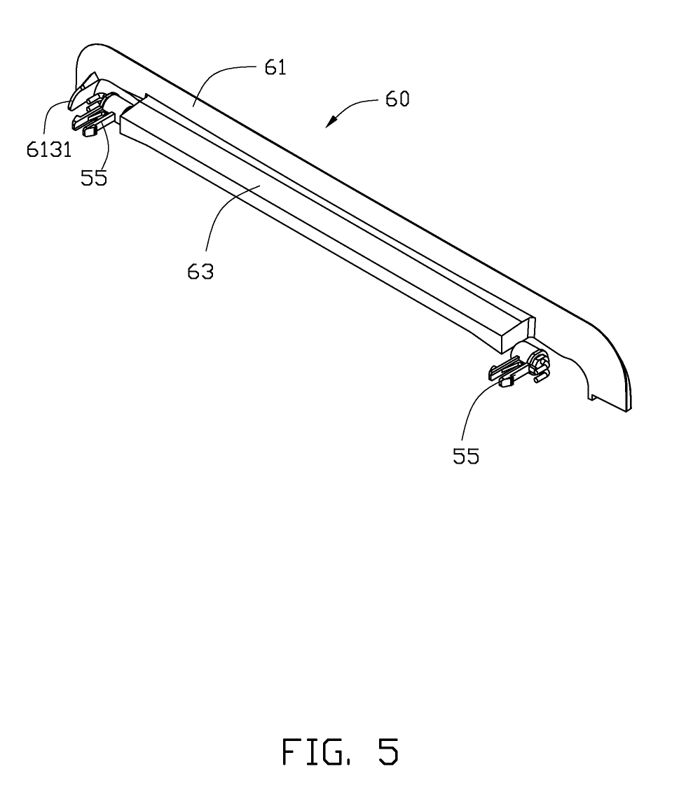

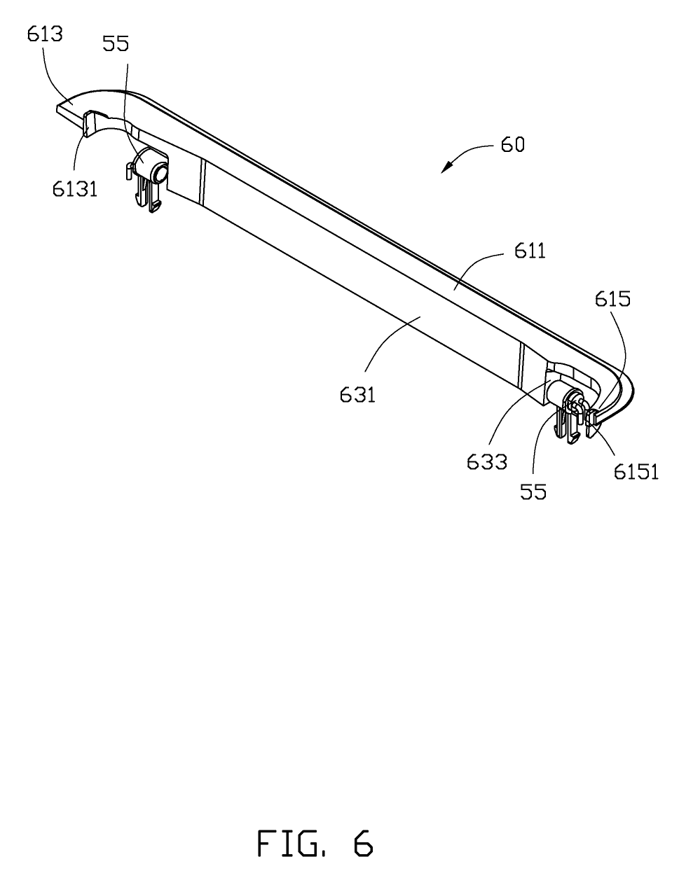

Referring to FIGS. 1 and 5, the light bar 80 includes a body 60 and a plurality of reflective sheets 70 attached to the body 60. The body 60 includes a bridge 61 and a light guiding portion 63 located on the bridge 61. Referring to FIG. 6, the bridge 61 includes a base portion 611, a first ending portion 613, and a second ending portion 615.

The first ending portion 613 extends from a first end of the base portion 611. A latching piece 6131 is located on one side of the first ending portion 613 and adjacent to the light guiding portion 63. A second ending portion 615 extends from a second end opposite to the first end of the base portion 611. A tab 6151 extends from a distal of the second ending portion 615. The light guiding portion 63 includes a narrow portion 631 and two wide portions 633 located on opposite sides of the narrow portion 631. In one embodiment, a cross-sectional area of the narrow portion 631 is smaller than a cross-sectional area of each of the two wide portions 633. The plurality of the reflective sheets 70 is attached to surfaces of the body 60.

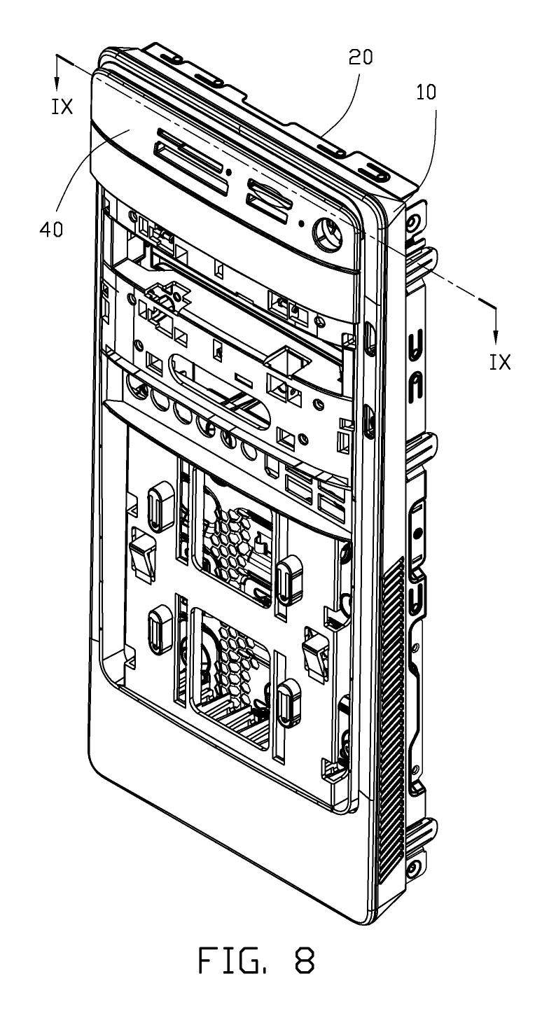

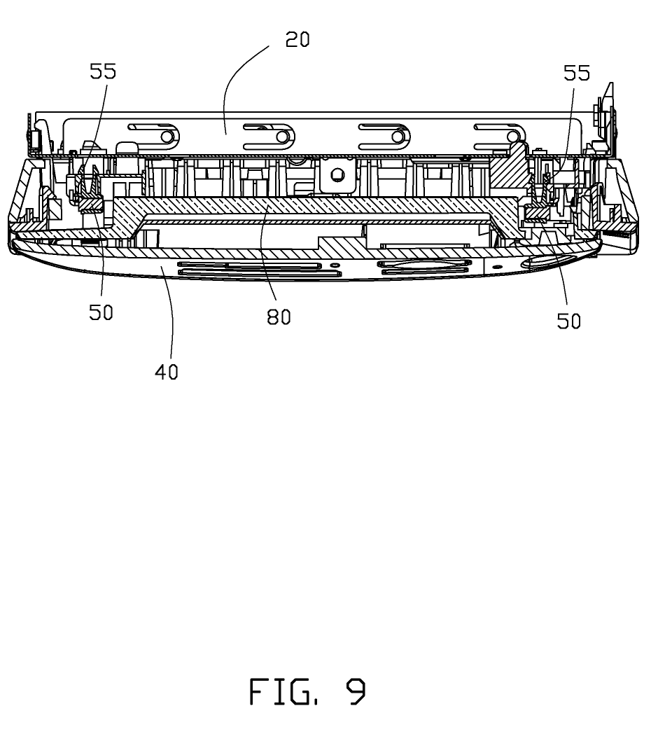

Referring to FIGS. 7-9, in assembly of the light bar 80 on the frame 10, the light guiding portion 63 is inserted into the installation opening 133. The body 60 is placed on the blocking portion 151 and the protrusion flange 171. The latching piece 6131 is engaged in the slot 153 and the tab 6151 is engaged in the recess 173. The bridge 61 is engaged between the limiting piece 155, the stopping piece 175, the blocking portion 151, and the protrusion flange 171.

The mounting member 55 with the light source 50 is installed to the bracket 21. The two hooks 553 are inserted through the through hole 211, and the clamping portion 5533 is engaged with the bracket 21. The front panel 20 is installed to the frame 20. Each of the light sources 50 is aligned with each of the two wide portions 633 of the light bar 80.

The cover 30 is installed to the frame 10 by the plurality of gripping portion 33 engaging with the frame 10. The light bar 80 is received in the opening 31.

The expansion board 40 is installed to the frame 10 to cover the light bar 80.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device comprising:
a frame comprising a first sidewall, a second sidewall, and a top wall connected to the first sidewall and the second sidewall;
a front panel secured to the frame;
a light bar comprising a body; and
two light sources installed on the front panel;
wherein a first supporting portion is located between the first sidewall and the top wall; a second supporting portion is located between the second sidewall and the top wall; the top wall, the first supporting portion and the second supporting portion cooperatively defining an installation hole; the body of the light bar comprises a bridge and a light guiding portion located on the bridge, the bridge being located on the first supporting portion and the second supporting portion; the light guiding portion is engaged in the installation hole; each of the light sources being aligned with two sides of the light guiding portion.

2. The electronic device of claim 1, wherein the light bar further comprises a plurality of reflective sheets, and each of the plurality of reflective sheets is attached to surfaces of the body.

3. The electronic device of claim 2, wherein the bridge comprises a base portion and a first ending portion extending from a first end of the base portion, a latching piece is located on the ending portion, a slot is defined in the first supporting portion, and the latching piece is engaged in the slot.

4. The electronic device of claim 3, wherein the bridge further comprises a second ending portion extending from a second end opposite to the first end of the base portion, a tab extends from a distal portion of the second ending portion, a recess is defined in the second supporting portion, and the tab is engaged in the recess.

5. The electronic device of claim 1, wherein a blocking portion is located on the first supporting portion, a limiting piece extends from the supporting portion, and the bridge is engaged between the blocking portion and the limiting piece.

6. The electronic device of claim 1, wherein a stopping piece extends from the second supporting portion, and the bridge is engaged between the stopping portion and the protrusion flange.

7. The electronic device of claim 1, wherein a plurality of pressing portions extends inward from the top wall, and the plurality of pressing portions abut the light guiding portion.

8. The electronic device of claim 1, wherein the light guiding portion comprises a narrow portion and two wide portions located on opposite ends of the narrow portion, and a cross-sectional area of the narrow portion is smaller than a cross-sectional area of each wide portion.

9. The electronic device of claim 8, wherein each of the two light sources is aligned with each of the two wide portions.

10. The electronic device of claim 1, wherein two brackets are located on the front panel, and each of two mounting members is engaged with each of the two brackets to secure each of the light sources.

11. An electronic device comprising:
a frame comprising a first sidewall, a second sidewall and a top wall connected to the first sidewall and the second sidewall;
a front panel secured to the frame;
two light sources installed on the front panel; and
a light bar comprising a body;
wherein a first supporting portion is located between the first sidewall and the top wall, a second supporting portion is located between the second sidewall and the top wall, a blocking portion is located on the supporting portion, a protrusion flange is located on the second supporting portion, a plurality of pressing portions extend from the top wall, the body comprises a bridge and a light guiding portion located on the bridge, a first end of the bridge being engaged with the first supporting portion, a second end of the bridge being engaged with the second supporting portion, the blocking portion and the protrusion flange abut the bridge, the pressing portions abut the light guiding portion, and each of the light sources being aligned with two opposite sides of the light guiding portion.

12. The electronic device of claim 11, wherein the bridge comprises a base portion and a first ending portion extending from a first end of the base portion, a latching piece is located on the ending portion, a slot is defined in the first supporting portion, and the latching piece is engaged in the slot.

13. The electronic device of claim 12, wherein the bridge further comprises a second ending portion extending from a second end opposite to the first end of the base portion, a tab extends from a distal portion of the second ending portion, a recess is defined in the second supporting portion, and the tab is engaged in the recess.

14. The electronic device of claim 11, wherein the light bar further comprises a plurality of reflective sheets, and each of the plurality of reflective sheets is attached to surfaces of the body.

15. The electronic device of claim 11, wherein the light guiding portion comprises a narrow portion and two wide portions located on two opposite sides of the narrow portion, and a cross-sectional area of the narrow portion is smaller than a cross-sectional area of each wide portion.

16. The electronic device of claim 15, wherein each of the two light sources is aligned with each of the two wide portions.

17. The electronic device of claim 11, wherein two mounting members are installed on the front panel, each of the two mounting members comprises a receiving portion adaptor to receive the light source.

18. The electronic device of claim 17, wherein two brackets are located on the front panel, each of the two brackets defines a through hole, each of the two mounting members further comprises two hooks, and the two hooks extend through the through holes to engage with the brackets.

19. The electronic device of claim 11, wherein a limiting piece extends from the first supporting portion, and the bridge is engaged between the limiting piece and the blocking portion.

20. The electronic device of claim 11, wherein a stopping piece extends from the second supporting portion, and the bridge is engaged between the stopping portion and the protrusion flange.
